(19) United States
(12) Patent Application Publication
(10) Pub. No.: US 2012/0088497 A1
(43) Pub. Date: Apr. 12, 2012

(54) RADIO SIGNAL LOSS TRACKER

(75) Inventors: Grzegorz Knapik, Krakow (PL); Albert Dabrowski, Krakow (PL); Bartosz Drzewinski, Bialystok (PL); Krzysztof A. Kloc, Krakow (PL); Konrad Liedtke, Szcecin (PL); Sylwester Pena, Krakow (PL); Michal Pytel, Krakow (PL); Michal Slusarczyk, Krakow (PL); Ireneusz Wlizlo, Wieliczka (PL)

(73) Assignee: Motorola, Inc., Schaumburg, IL (US)

(21) Appl. No.: 12/901,876

(22) Filed: Oct. 11, 2010

(51) Int. Cl. H04W 24/00

(52) U.S. Cl. 455/423

(57) ABSTRACT

A mobile telephone is described. The mobile telephone includes a radio transceiver for transmitting a radio signal based on a measured signal strength of a cellular signal received from a remote transceiver. A processor is coupled to the radio transceiver. The processor monitors the measured signal strength over time and determines when the measured signal strength decreases to a predetermined threshold. A memory is coupled to the radio transceiver for storing the measured signal strength. A display indicates a time when the measured signal strength decreases to the predetermined threshold.

### TECHNICAL FIELD

The invention relates generally to monitoring the signal strength of mobile telephones.

### BACKGROUND

Cellular telephones generally include transceivers that receive radio signals from a cellular network via remote cellular radio towers. The strength of the received signal is generally indicated on the display of the cellular telephone as a series of adjacent vertical lines. The number of lines indicated is a gauge of the expected quality of the transmission and reception of cellular calls at a particular location.

### SUMMARY

In one aspect, the invention is embodied in a mobile telephone including a radio transceiver for transmitting a radio signal based on a measured signal strength of a cellular signal received from a remote transceiver. A processor is coupled to the radio transceiver. The processor monitors the measured signal strength over time and determines when the measured signal strength decreases to a predetermined threshold. A memory is coupled to the radio transceiver for storing the measured signal strength. A display is coupled to the memory and indicates a time when the measured signal strength decreases to the predetermined threshold.

In one embodiment, the radio transceiver receives a radio signal from the remote transceiver. The radio transceiver can receive a cellular signal from at least one of the remote transceiver and a second remote transceiver. The predetermined threshold can correspond to a lost signal condition. The mobile telephone can also include an antenna coupled to the radio transceiver for receiving the cellular signal.

The mobile telephone can also include a global positioning system (GPS) that is coupled to the processor. The display can indicate a location of the mobile telephone when the measured signal strength decreases to the predetermined threshold. In another embodiment, the display can indicate a period of time when the measured signal strength is below the predetermined threshold.

In another aspect, the invention is embodied in a method including receiving a signal from a remote transceiver. The method also includes measuring a signal strength of the cellular signal received from the remote transceiver. The measured signal strength is monitored over time to determine when the measured signal strength decreases to a predetermined threshold. The measured signal strength is stored and the time when the measured signal strength decreases to the predetermined threshold is displayed.

The method can further include transmitting a radio signal to the remote transceiver. The predetermined threshold can correspond to a lost signal condition. A location can be determined using a global positioning system (GPS). The location when the measured signal strength decreases to the predetermined threshold can be indicated. In another embodiment, the measured signal strength and the time can be indicated when the measured signal strength decreases to the predetermined threshold.

In another aspect, the invention is embodied in a mobile telephone. The mobile telephone includes a means for receiving a cellular signal from a remote transceiver. The mobile telephone also includes a means for measuring a signal strength of the cellular signal received from the remote transceiver. A means for monitoring the measured signal strength over time and determining when the measured signal strength decreases to a predetermined threshold is also included. The mobile telephone also includes a means for storing the measured signal strength and a means for displaying a time when the measured signal strength decreases to the predetermined threshold.

The mobile telephone can also include a means for transmitting a radio signal to the remote transceiver. In one embodiment, the predetermined threshold corresponds to a lost signal condition. The mobile telephone can also include a means for determining a location of the mobile telephone. The location can be indicated when the measured signal strength decreases to the predetermined threshold. In one embodiment, the measured signal strength and the time can be indicated when the measured signal strength decreases to the predetermined threshold.

### BRIEF DESCRIPTION OF THE FIGURES

Skilled artisans will appreciate that elements in the figures are illustrated for simplicity and clarity and have not necessarily been drawn to scale. For example, the dimensions of some of the elements in the figures may be exaggerated relative to other elements to help improve understanding of various embodiments. In addition, the description and drawings do not necessarily require the order illustrated. It will be further appreciated that certain actions and/or steps may be described or depicted in a particular order of occurrence while those skilled in the art will understand that such specificity with respect to sequence is not actually required. Apparatus and method components have been represented where appropriate by conventional symbols in the drawings, showing only those specific details that are pertinent to understanding the various embodiments so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

The above and further advantages of this invention may be better understood by referring to the following description in conjunction with the accompanying drawings, in which like numerals indicate like structural elements and features in various figures. Skilled artisans will appreciate that reference designators shown herein in parenthesis indicate components shown in a figure other than the one in discussion. For example, talking about a device (10) while discussing Figure A would refer to an element, 10, shown in figure other than Figure A.

FIG. 1 is a front view of a mobile telephone according to one embodiment of the invention.

FIG. 2 is a block diagram illustrating the electronic components of the mobile telephone of FIG. 1.

FIG. 3 illustrates three views of a display of a mobile telephone according to one embodiment of the invention

FIG. 4 illustrates a table of tracked times and dates during a period when the measured signal strength was adequate to transmit a cellular call.

FIG. 5 illustrates a display of a mobile telephone according to one embodiment of the invention.

FIG. 6 illustrates a table of tracked times, locations and dates during a period when the measured signal strength was adequate to transmit a cellular call

### DETAILED DESCRIPTION

The following detailed description is merely illustrative in nature and is not intended to limit the invention or the application and uses of the invention. Furthermore, there is no intention to be bound by any express or implied theory presented in the preceding technical field, background, brief summary or the following detailed description. For the purposes of conciseness, many conventional techniques and principles related to conventional cellular telephones, need not, and are not, described in detail herein.

Techniques and technologies may be described herein in terms of functional and/or logical block components and various processing steps. It should be appreciated that such block components may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

The following description may refer to elements or nodes or features being “connected” or “coupled” together. As used herein, unless expressly stated otherwise, “connected” means that one element/node/feature is directly joined to (or directly communicates with) another element/node/feature, and not necessarily mechanically. Likewise, unless expressly stated otherwise, “coupled” means that one element/node/feature is directly or indirectly joined to (or directly or indirectly communicates with) another element/node/feature, and not necessarily mechanically. The term “exemplary” is used in the sense of “example, instance, or illustration” rather than “model,” or “deserving imitation.”

Technologies and concepts discussed herein relate to systems utilizing cellular telephones. In an exemplary embodiment, a mobile telephone can indicate a time when a signal strength falls below a predetermined threshold required to transmit and/or receive a telephone call. The system can also indicate the location of the mobile telephone at the time when the signal strength fell below the predetermined threshold.

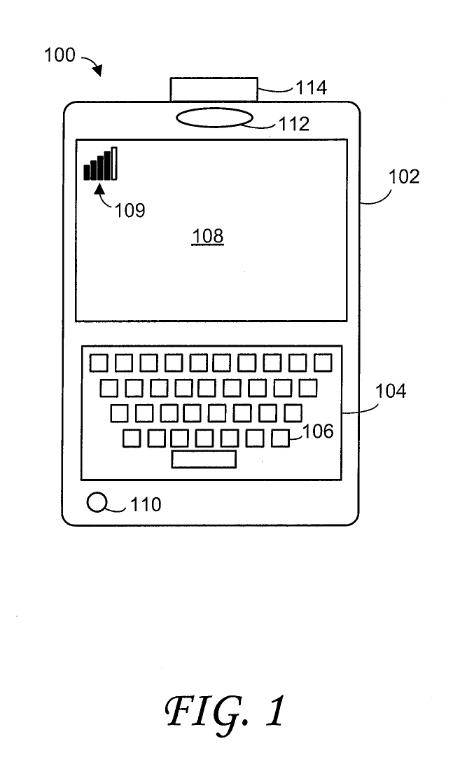

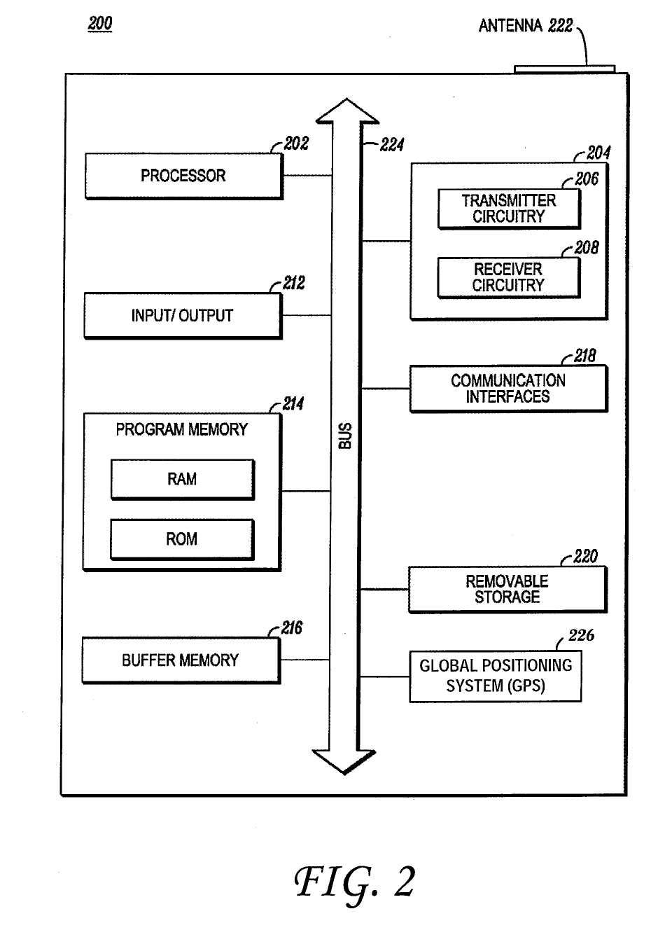

FIG. 1 is a front view of a mobile telephone 100 according to one embodiment of the invention. The mobile telephone 100 includes a housing 102. The housing 102 contains electronic components, including internal communication components and circuitry as further described with relation to FIG. 2 to enable the telephone 100 to communicate wirelessly with other telephones. The housing 102 also contains I/O devices such as a keyboard 104 with alpha-numeric keys 106, a display 108 (e.g., LED, OELD) that displays information about the telephone 100, such as a signal strength indicator 109, soft and/or hard keys, touch screen, jog wheel, a microphone 110, and a speaker 112. The mobile telephone 100 can also include a global positioning system (GPS) (not shown), which can track the location of the mobile telephone 100. In some embodiments, the mobile telephone 100 includes more or less than all of the I/O devices shown in FIG. 1.

FIG. 2 is a block diagram 200 illustrating the electronic components of the mobile telephone 100 (FIG. 1) according to the invention. The mobile telephone 100 contains, among other components, a processor 202, a transceiver 204 including transmitter circuitry 206 and receiver circuitry 208, an antenna 222, the I/O devices 212 described in relation to FIG. 1, a program memory 214 for storing operating instructions that are executed by the processor 202, a buffer memory 216, one or more communication interfaces 218, an optional removable storage 220, and a global positioning system (GPS) 226. The mobile telephone 100 is preferably an integrated unit containing the elements depicted in FIG. 2, as well as any other element necessary for the mobile telephone 100 to function. In one embodiment, the electronic components are connected by a bus 224.

The processor 202 can include one or more microprocessors, microcontrollers, DSPs, state machines, logic circuitry, or any other device or devices that process information based on operational or programming instructions. Such operational or programming instructions are preferably stored in the program memory 214. The program memory 214 can be an IC memory chip containing any form of random access memory (RAM) or read only memory (ROM), a floppy disk, a compact disk (CD) ROM, a hard disk drive, a digital video disk (DVD), a flash memory card or any other medium for storing digital information. Skilled artisans will recognize that when the processor 202 has one or more of its functions performed by a state machine or logic circuitry, the program memory 214 containing the corresponding operational instructions may be embedded within the state machine or logic circuitry. Operations performed by the processor 202 as well as the mobile telephone 100 are described in detail below.

The transmitter circuitry 206 and the receiver circuitry 208 enable the mobile telephone 100 to respectively transmit and receive communication signals. In this regard, the transmitter circuitry 206 and the receiver circuitry 208 include circuitry to enable wireless transmissions. The implementations of the transmitter circuitry 206 and the receiver circuitry 208 depend on the implementation of the mobile telephone 100 and the cellular network and telephones with which it is to communicate. In one embodiment, the transmitter and receiver circuitry 206, 208 can be implemented as part of the communication device hardware and software architecture in accordance with known techniques. For example, the mobile telephone 100 can communicate through a cellular network such as a code division multiple access (CDMA) network or a global system for mobile communications (GSM) network.

One of ordinary skill in the art will recognize that most, if not all, of the functions of the transmitter or receiver circuitry 206, 208 can be implemented in a processor, such as the processor 202. However, the processor 202, the transmitter circuitry 206, and the receiver circuitry 208 have been partitioned herein to facilitate a better understanding of the functions of these elements. In one embodiment, the antenna 222 is a cellular antenna coupled to the transceiver 204.

The buffer memory 216 may be any form of volatile memory, such as RAM, and is used for temporarily storing received information. The removable memory 220 can be a secure digital (SD) memory card, for example.

The global positioning system (GPS) 226 can be implemented as a module within the mobile telephone 100. The module includes a satellite receiver that communicates with global positioning satellites to provide a position of the mobile telephone 100. Global positioning systems use the technique of triangulation to determine the position of a GPS receiver on the surface of the Earth.

In operation, a user transmits and receives calls and/or data from a mobile telephone 100. The mobile telephone 100 includes a transceiver 204 that measures signal strength received from a cellular network. The measured signal strength determines whether or not the mobile telephone 100 is capable of transmitting and receiving cellular calls and data at the current location of the mobile telephone 100.

In one embodiment, the measured signal strength is monitored over time by a software application executing on the processor 202. The software application executing on the processor 202 determines when the measured signal strength decreases to a predetermined threshold. The predetermined threshold can correspond to a lost signal condition. In one embodiment, the measured signal strength is stored in the memory 214. The software continues to monitor the signal strength over time as the user relocates the mobile telephone 100. The monitoring can be periodic or substantially continuous. The periodic monitoring can implement a learning algorithm to determine an efficient monitoring schedule. For example, the algorithm can increase the time period between signal strength measurements if the mobile telephone 100 is located in an area having a strong measured signal for an extended period of time.

In the event that the mobile telephone 100 enters a location having poor signal strength, the software tracks a time when the measured signal strength decreases to the predetermined threshold. The software instructs the processor 202 to display the time when the measured signal strength decreased to the predetermined threshold. In one embodiment, the time indicator (not shown) can then replace the signal strength indicator 109 on the display 108 of the mobile telephone 100. In the event that the measured signal strength increases above the predetermined threshold, the display 108 can return to a normal state and the signal strength indicator 109 can be restored.

In one embodiment, the mobile telephone 100 includes a GPS module that can track the location of the mobile telephone 100. In this embodiment, both the time and the location of the mobile telephone 100 can be simultaneously displayed on the display 108 when the measured signal strength decreases to the predetermined threshold. In the event that the measured signal strength increases above the predetermined threshold, the display 108 can return to a normal state and the signal strength indicator 109 can be restored.

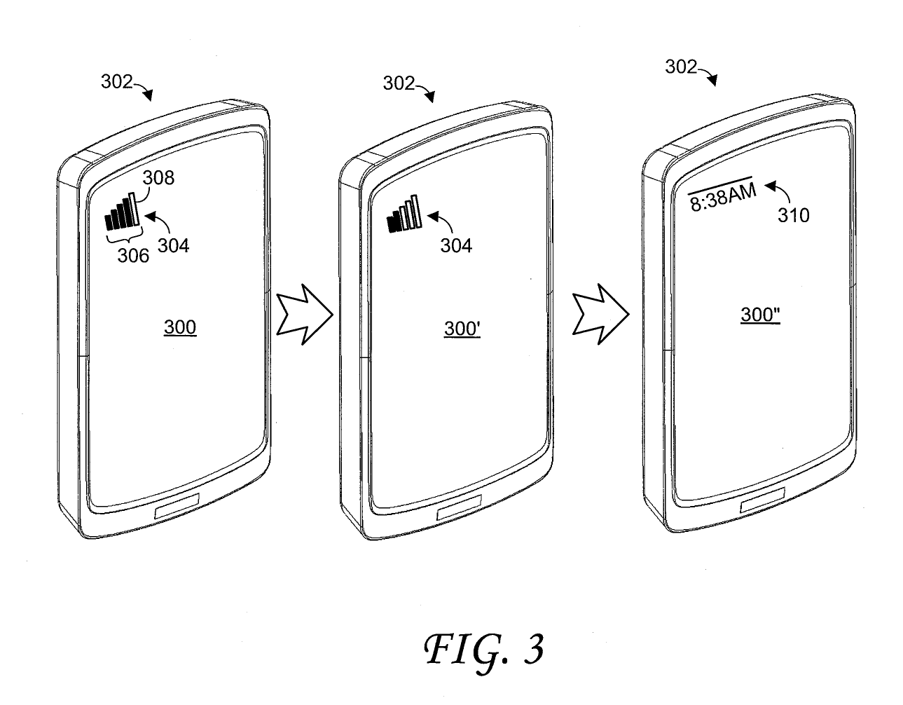

FIG. 3 illustrates three views of a display 300, 300′, 300″ of a mobile telephone 302 according to one embodiment of the invention. The display 300 is shown having a signal strength meter 304. The signal strength meter 304 includes a plurality of vertical lines 306. The number of vertical lines 306 shown in the signal strength meter 304 is an indication of the strength of the cellular signal being received by the mobile telephone 302. In some embodiments, a phantom outline 308 is included around each vertical line to gauge the signal strength relative to a maximum signal strength. Although the signal strength is indicated as a plurality of vertical lines, it should be appreciated that any type of signal strength indicator can be used. For example, the signal strength meter 304 could be a gas gauge type meter, a series of color indicators such as red, yellow, green, or a number indication, such as 0-100.

The display 300 indicates a signal strength of four bars (vertical lines) out of a possible five bars. This signal strength meter 304 indicates that the mobile telephone 302 is in a location having good cellular network coverage. For example, an indication of four bars means that it is unlikely that the mobile telephone 302 will drop a cellular call currently in process or will have difficulty connecting to the cellular network.

The display 300′ indicates a signal strength of two bars (vertical lines) out of a possible five bars. The signal strength meter 304 indicates that the mobile telephone 302 is in a location having fair cellular network coverage. For example, an indication of two bars means that it is possible that the mobile telephone 302 will drop a cellular call currently in process or otherwise be prevented from completing a call at the current location.

In some embodiments, if a mobile telephone 302 is unable to complete a call, it may try to roam to a different cellular network. In wireless telecommunications, roaming is a general term referring to the extension of connectivity service in a location that is different from the home location where the service was registered. Roaming ensures that the wireless telephone is kept connected to the network, without losing the connection. The term “roaming” originates from the GSM (global system for mobile communications) sphere; the term “roaming” can also be applied to the CDMA (code division multiple access) technology. Traditional GSM Roaming is defined as the ability for a cellular customer to automatically make and receive voice calls, send and receive data, or access other services, including home data services, when travelling outside the geographical coverage area of the home network, by means of using a visited network. This can be done by using a communication terminal or else just by using the subscriber identity in the visited network. Roaming is technically supported by mobility management, authentication, authorization and billing procedures as is known by skilled artisans.

The display 300″ indicates a time 310 of 8:38 AM. This represents the time that the mobile telephone 302 last possessed adequate signal strength to transmit or receive a call. Thus, the display 300″ indicates that the mobile telephone 302 was in a location having cellular network coverage at the time 310. For example, the mobile telephone 302 would be capable of completing a call if the mobile telephone 302 returned to the location corresponding to 8:38 AM. In one embodiment, the display 300″ changes from a time indication 310 to a signal strength indicator 304 when the mobile telephone 302 returns to a location having adequate network coverage.

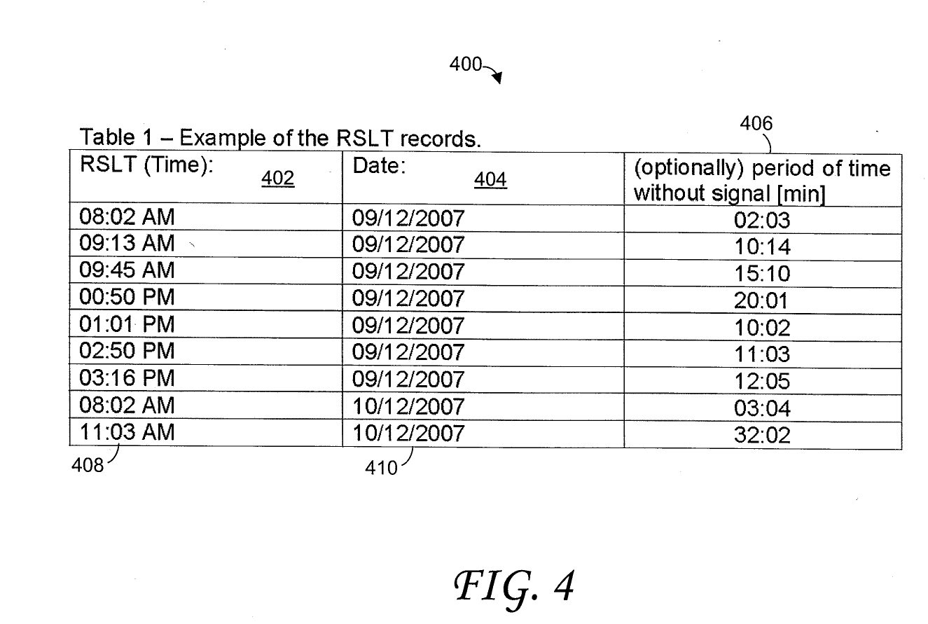

FIG. 4 illustrates a table 400 of tracked times 402 and dates 404 during a period when the measured signal strength was adequate to transmit a cellular call. In one embodiment, the period of time 406 when no adequate cellular signal was measured by the mobile telephone 302 can also be tracked. The memory 214 (FIG. 2) can store the table 400 and the processor 202 can instruct the display 300 to display relevant data from the table 400 at the appropriate time (e.g., when the signal strength decreased to a predetermined threshold corresponding to a lost signal condition). For example, the table 400 indicates that the last occasion a cellular signal was lost was at a time 408 of 11:03 AM on the date 410 of Oct. 12, 2007.

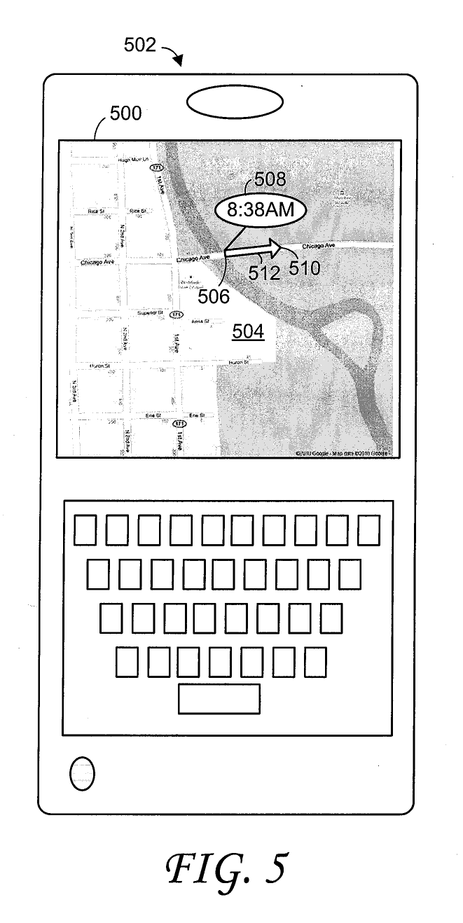

FIG. 5 illustrates a display 500 of a mobile telephone 502 according to one embodiment of the invention. The mobile telephone 502 includes a GPS receiver (not shown). The GPS receiver tracks the location of the mobile telephone 502. In one embodiment, the display 500 is shown with a map 504.

In operation, the display 500 can display a signal strength meter, such as the signal strength meter 300 (FIG. 3) including a plurality of vertical lines (not shown) when the mobile telephone 502 is located in an area having adequate network coverage. The number of vertical lines in the signal strength meter is an indication of the strength of the cellular signal being received by the mobile telephone 502.

In the event the mobile telephone 502 is moved to a location having inadequate network coverage, the display 500 shows the map 504 indicating a location 506 and a time 508 of 8:38 AM. This represents the location 506 and the time 508 that the mobile telephone 502 last possessed adequate signal strength to transmit or receive a call. Thus, the display 500 indicates that the mobile telephone 502 was in the location 506 and had adequate cellular network coverage at the time 508 of 8:38 AM. For example, the mobile telephone 502 would be capable of completing a call if the mobile telephone 502 returned to the location 506 corresponding to the time 508 of 8:38 AM.

Additionally, the map 504 can indicate the current location 510 of the mobile telephone 502. In this embodiment, the display 500 indicates the route 512 of the mobile telephone 502. In one embodiment, the display 500 can change from displaying a location and time to displaying a signal strength indicator when the mobile telephone 502 returns to a location having adequate network coverage.

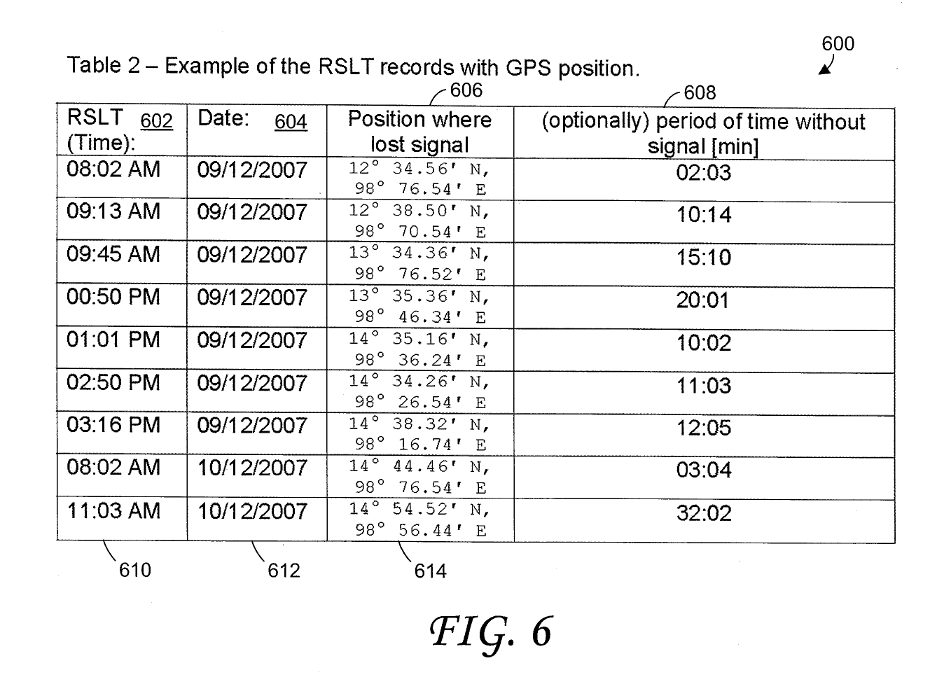

FIG. 6 illustrates a table 600 of tracked times 602, dates 604 and locations 606 during a period when the measured signal strength was adequate to transmit a cellular call. In one embodiment, the period of time 608 when no adequate cellular signal was measured by the mobile telephone 502 can also be tracked.

The memory 214 (FIG. 2) can store the table 600 and the processor 202 can instruct the display 500 to display relevant data from the table 600 at the appropriate time (e.g., when the signal strength decreased to a predetermined threshold corresponding to a lost signal condition). For example, the table 600 indicates that the last occasion a signal was lost was at the time 610 of 11:03 AM on the date 612 of Oct. 12, 2007 and the mobile telephone 502 was at the location 606 corresponding to the coordinates 614 (14° 54.52° N, 98° 56.44° E).

In general, the processor 202 (FIG. 2) of the mobile telephone 200 includes processing logic configured to carry out the functions, techniques, and processing tasks associated with the operation of the mobile telephone 200. Furthermore, the steps of a method or algorithm described in connection with the embodiments disclosed herein may be embodied directly in hardware, in firmware, in a software module executed by the processor 202, or any combination thereof. Any such software may be implemented as low level instructions (assembly code, machine code, etc.) or as higher-level interpreted or compiled software code (e.g., C, C++, Objective-C, Java, Python, etc.).

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and apparatus for the near-field wireless device pairing described herein. The non-processor circuits may include, but are not limited to, a radio receiver, a radio transmitter, signal drivers, clock circuits, power source circuits, and user input devices. As such, these functions may be interpreted as steps of a method to perform the near-field wireless device pairing described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Both the state machine and ASIC are considered herein as a “processing device” for purposes of the foregoing discussion and claim language.

Moreover, an embodiment can be implemented as a computer-readable storage element or medium having computer readable code stored thereon for programming a computer (e.g., comprising a processing device) to perform a method as described and claimed herein. Examples of such computer-readable storage elements include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

While at least one example embodiment has been presented in the foregoing detailed description, it should be appreciated that a vast number of variations exist. It should also be appreciated that the example embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

In addition, the section headings included herein are intended to facilitate a review but are not intended to limit the scope of the present invention. Accordingly, the specification and drawings are to be regarded in an illustrative manner and are not intended to limit the scope of the appended claims.

In interpreting the appended claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) any of the disclosed elements may be comprised of hardware portions (e.g., including discrete and integrated electronic circuitry), software portions (e.g., computer programming), and any combination thereof;

f) hardware portions may be comprised of one or both of analog and digital portions;

g) any of the disclosed devices or portions thereof may be combined together or separated into further portions unless specifically stated otherwise; and

h) no specific sequence of acts or steps is intended to be required unless specifically indicated.

What is claimed is:

1. A mobile telephone comprising:
a radio transceiver for transmitting a radio signal based on a measured signal strength of a cellular signal received from a remote transceiver;
a processor coupled to the radio transceiver, the processor monitoring the measured signal strength over time and determining when the measured signal strength decreases to a predetermined threshold;
a memory coupled to the radio transceiver for storing the measured signal strength; and
a display coupled to the memory for indicating a time when the measured signal strength decreases to the predetermined threshold.

2. The mobile telephone of claim 1, wherein the radio transceiver receives a radio signal from the remote transceiver.

3. The mobile telephone of claim 1, wherein the radio transceiver receives a cellular signal from at least one of the remote transceiver and a second remote transceiver.

4. The mobile telephone of claim 1, wherein the predetermined threshold corresponds to a lost signal condition.

5. The mobile telephone of claim 1, further comprising a global positioning system (GPS) coupled to the processor.

6. The mobile telephone of claim 5, wherein the display indicates a location of the mobile device when the measured signal strength decreases to the predetermined threshold.

7. The mobile telephone of claim 1, wherein the display indicates a period of time when the measured signal strength is below the predetermined threshold.

8. The mobile telephone of claim 1, further comprising an antenna coupled to the radio transceiver for receiving the cellular signal.

9. A method comprising:
receiving a cellular signal from a remote transceiver;
measuring a signal strength of the cellular signal received from the remote transceiver;
monitoring the measured signal strength over time and determining when the measured signal strength decreases to a predetermined threshold;
storing the measured signal strength; and
displaying a time when the measured signal strength decreases to the predetermined threshold.

10. The method of claim 9 further comprising transmitting a radio signal to the remote transceiver.

11. The method of claim 9, wherein the predetermined threshold corresponds to a lost signal condition.

12. The method of claim 9, further comprising determining a location using a global positioning system (GPS).

13. The method of claim 12, further comprising indicating a location when the measured signal strength decreases to the predetermined threshold.

14. The method of claim 9, further comprising indicating a period of time when the measured signal strength is below the predetermined threshold.

15. A mobile telephone comprising:
means for receiving a cellular signal from a remote transceiver;
means for measuring a signal strength of the cellular signal received from the remote transceiver;
means for monitoring the measured signal strength over time and determining when the measured signal strength decreases to a predetermined threshold;
means for storing the measured signal strength; and
means for displaying a time when the measured signal strength decreases to the predetermined threshold.

16. The mobile telephone of claim 15 further comprising means for transmitting a radio signal to the remote transceiver.

17. The mobile telephone of claim 15, wherein the predetermined threshold corresponds to a lost signal condition.

18. The mobile telephone of claim 15 further comprising means for determining a location of the mobile telephone.

19. The mobile telephone of claim 15 further comprising means for indicating a location when the measured signal strength decreases to the predetermined threshold.

20. The mobile telephone of claim 15 further comprising means for indicating a period of time when the measured signal strength is below the predetermined threshold.
